(19) United States
(12) Patent Application Publication
(10) Pub. No.: US 2014/0059535 A1
(43) Pub. Date: Feb. 27, 2014

(54) Software Inventory Using a Machine Learning Algorithm

(71) Applicant: International Business Machines Corporation, Armonk, NY (US)

(72) Inventors: Pawel Gocek, Krakow (PL); Piotr Kania, Krakow (PL); Tomasz Stopa, Krakow (PL)

(21) Appl. No.: 13/915,910

(22) Filed: Jun. 12, 2013

(30) Foreign Application Priority Data
Aug. 21, 2012 (GB) 1214855.7

(51) Int. Cl. G06F 9/445

(52) U.S. Cl. CPC G06F 8/60
USPC 717/174

(57) ABSTRACT

A software inventory method, comprising storing data representative of a logic engine established via a machine learning algorithm, detecting a software item on a computer system, determining at least one parameter of the software item, estimating, using the logic engine and the at least one parameter, a category of the software item, and communicating the at least one parameter to another computer system in response to the estimated category is a given category.

### BACKGROUND

The present disclosure is an invention disclosure relating to a software inventory method, a software inventory system as well as a corresponding computer program product.

It is known to maintain an inventory of the software installed on a computing device. Such an inventory may be used for determining when it is appropriate to update software installed on the computing device, for determining license fees that may be incurred by virtue of installation of the software on the computing device, etc. For maintaining the inventory, it is likewise know to employ a set of software discovery rules that stipulate how to assess what software is installed on the computing device.

The present disclosure expounds upon this background.

### SUMMARY

In one illustrative embodiment, a method is provided for performing a software inventory. The illustrative embodiment stores data representative of a logic engine established via a machine learning algorithm. The illustrative embodiment detects a software item on a computer system. The illustrative embodiment determines at least one parameter of the software item. The illustrative embodiment estimates, using the logic engine and the at least one parameter, a category of the software item. The illustrative embodiment communicates the at least one parameter to another computer system in response to the estimated category is a given category.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE SEVERAL VIEWS OF THE DRAWINGS

FIG. 1A schematically shows an embodiment of a software inventory system in accordance with the present disclosure;

FIG. 2 schematically shows another embodiment of a software inventory system in accordance with the present disclosure;

FIG. 3 schematically shows another embodiment of a software inventory system in accordance with the present disclosure;

FIG. 4 schematically shows a flow diagram of an embodiment of a software inventory method in accordance with the present disclosure; and

FIG. 5 schematically shows a flow diagram of another embodiment of a software inventory method in accordance with the present disclosure.

### DETAILED DESCRIPTION

Loosely speaking, the present disclosure teaches a software inventory method that employs a logic engine obtained using a machine learning algorithm to assess whether a newly detected file should be considered for inventory. The logic engine may be obtained by feeding a large number of positive and negative examples (e.g. tens of thousands) to a machine learning algorithm. The logic engine, e.g. a neural network, can be seen as a compact representation of the data fed to the machine learning algorithm, just as the human brain provides a compact representation of a person's knowledge and lifelong experiences. The compactness of the logic engine is “bought” by the processing time required by the machine learning algorithm to generate the logic engine. Processing of subject data using the logic engine is extremely swift compared to the time required to prepare a logic engine representative of a large pool of data. The logic engine may be generated at an inventory server and communicated to a plurality of clients, e.g. end-user computers, thus allowing the clients to swiftly estimate the relationship of subject data to data represented by the logic engine with high accuracy, e.g. upward of 90%, thus reducing unnecessary communication of data between the server and the clients.

Still loosely speaking, the present disclosure teaches, as touched upon above, a software inventory method that can be carried out at a client side and a software inventory method that can be carried out at a server side of a system. At a client side, the method may comprise (occasionally) receiving a logic engine from a server, categorizing newly found files by processing one or more parameters of the file (e.g. file size, file name, file extension, etc.) using the logic engine and communicating the file parameters to the server if the file is considered to belong to a category of files subject to inventorying. At the server side, the method may comprise generating a logic engine using file parameters of a large set of categorized files (e.g. categorized into files subject to inventory such as commercial software and files not subject to inventory such as temporary files and user-created files).

In one aspect, as touched upon supra, the present disclosure relates to a software inventory method, e.g. as described above.

The method may comprise storing data representative of a logic engine, e.g. a logic engine established by means of a machine learning algorithm. Similarly, the method may comprise receiving data representative of a logic engine.

The logic engine may be a set of rules and/or mathematical functions that define an output (value) as a function of one or more inputs (i.e. a set of input operands or input values). As such, the logic engine may be (non-trivially) representative of a pool of data comprising over ten thousand sets of input operands and, for each of the input sets, an output (value) individually associated with the respective input set. In other words, the logic engine may be (non-trivially) representative of an output associated with each input set of a collection of over ten thousand input sets. The data may represent the logic engine in any (appropriate) manner.

The machine learning algorithm may comprise any (type of) machine learning algorithm, e.g. a neural network algorithm, a fuzzy clustering algorithm, a regression analysis algorithm, a decision tree algorithm, etc. As such, the logic engine may comprise a neural network, fuzzy logic, a regression model, a decision tree, etc.

The method may comprise detecting a software item on a computer system. The computer system may comprise one or more end-user computers and may comprise one or more data storage devices, e.g. data storage devices networked to end-user computers. The software item may be any data file, e.g. a file comprising resources required by an application, a file comprising executable binary data such as a computer application, or a system log file. The detecting may be carried out by a dedicated application that scans all or part of a file system of the computer system for new and/or altered files. The detecting may be carried out intermittently, e.g. at a given time interval.

The method may comprise determining at least one parameter of the software item, e.g. determining a file size, a file name and/or a file extension of the software item.

The method may comprise estimating a category of the software item, e.g. using the logic engine and/or any (one or more or each) of the at least one parameter. For example, the method may comprise estimating whether the software item belongs to a category of files subject to inventory. Similarly, the method may comprise estimating whether the software item belongs to a category of files not subject to inventory. The estimating may be carried out by inputting any (one or more or each) of the at least one parameter to the logic engine and receiving an output from the logic engine, e.g. an output indicative of a (most likely) category of a software item having the input parameters. The category may be a category selected from the group comprising applications, application support data, user data, applications of a given company, etc.

The method may comprise communicating any (one or more or each) of the at least one parameter to another computer system, i.e. to a computer system other than the computer system on which the software item was detected. The communicating may be carried out if (and only if) the estimated category is a given category, e.g. if the software item is estimated to belong to a category of files subject to inventory. The communicating may be carried via a wired or a wireless network connection.

The method may comprise comparing communicated parameters with (corresponding) parameters stored in a (inventory) database. For example, the communicated parameters may be compared at the another computer system with parameters stored in a database of the another computer system; a communicated parameter representative of a file name may be compared with stored parameters respectively representative of a file name, a communicated parameter representative of a file size may be compared with stored parameters respectively representative of a file size, etc.

The method may comprise receiving a user input indicative of whether to store the communicated parameters in a (inventory) database. Similarly, the method may comprise receiving a user input indicative of a category of the software item associated with the communicated parameters. The communicated parameters may be stored in the (inventory) database together with an indication of the category of the software item associated with the communicated parameters. For example, if the communicated parameters do not match parameters stored in the database, the communicated parameters may be displayed to a user. Based on the displayed parameters, a user may judge the category of the software item associated with the communicated parameters and effect a corresponding user input. The database may then be updated accordingly. Furthermore, the updated database parameters and data may be used to update the logic engine, i.e. to generate another logic engine that may be communicated to the computer system on which the software item was detected.

The logic engine may be non-trivially representative, for each of a plurality of mutually distinct software items, of a category (of software items) to which the respective software item belongs. For example, the logic engine may be non-trivially representative, for each of the plurality of mutually distinct software items and using one or more parameters of the respective software item as an input operand of the logic engine, of a category of the respective software item. The parameters may include any (one or more or all) of a file size, a file name and a file extension of the respective software item. As touched upon above, the category may be a category selected from the group comprising applications, application support data, user data, applications of a given company, etc. The method may comprise storing the parameters, e.g. as a first plurality of parameters. Similarly, the method may comprise storing data representative of the respective categories. As such, the method may comprise storing a (first) plurality of parameters for each of a plurality of mutually distinct software items and may comprise storing, for each of the plurality of mutually distinct software items, (first) data representative of a category of the respective software item. For example, the method may comprise storing a file size, a file name, a file extension and a category for each of the plurality of mutually distinct software items. The storing (of parameters/data) may be carried out by/at a computer system that establishes a logic engine. As such, the storing of parameters may be carried out by/at a computer system that differs from a computer system on which the software item was detected and from which the parameters were obtained. The storing (of parameters/data) may be carried out in a (inventory) database.

The plurality of mutually distinct software items may be software items stored on a computer system, e.g. software items installed on an end-user computer. The plurality of mutually distinct software items may be determined by establishing a list of all software items located in one or more given directories of the computer system. The establishing may be carried out such that no software items are listed twice. The list may be complemented at regular intervals. In other words, the list may include historic entries and not just represent a current “snapshot” of the software items located in the given directories. The plurality of mutually distinct software items may comprise more than ten thousand mutually distinct software items.

The logic engine may be established (by positive example) by feeding, for each of the plurality of software items, one or more parameters (e.g. the stored (first) plurality of parameters) representative of the respective software item to the machine learning algorithm together with data (e.g. the stored (first) data) indicative of the category of the respective software item. Similarly, the logic engine may be established (by negative example) by feeding, for each of the plurality of software items, one or more parameters representative of the respective software item to the machine learning algorithm together with data indicative of a category to which the respective software item does not belong. For example, the logic engine may be established by positive and negative example. As touched upon above, the parameters may include any (one or more or all) of a file size, a file name and a file extension of the respective software item. As such, the method may comprise establishing, using a machine learning algorithm using the (first) plurality of parameters and the (first) data as input operands, a (first) logic engine that is non-trivially representative, for each of the plurality of mutually distinct software items, of the category of the respective software item. The method may comprise communicating (data representative of) the (first) logic engine to each of a plurality of computer systems, e.g. to a plurality of end-user computers.

The plurality of mutually distinct software items may comprise (a plurality of) software items belonging to a first category but not a second category. Similarly, the plurality of mutually distinct software items may comprise (a plurality of) software items belonging to the second category but not the first category. For example, the plurality of mutually distinct software items may comprise at least one thousand software items belonging to a first category (e.g. software items subject to inventory) but not a second category (e.g. software items not subject to inventory) and at least one thousand software items belonging to the first category but not the second category.

The method may comprise receiving a (second) plurality of parameters for a(nother) software item, e.g. at a computer system that establishes a logic engine. For example, such further parameters can be received subsequent to establishment of a first logic engine, e.g. from a computer system that has detected a new software item and estimated, based on the first logic engine, that the software item is subject to inventory. Furthermore, the method may comprise receiving, e.g. as a user input, (second) data representative of a category of the (another) software item. As touched upon above, the received parameters may be displayed to a user. Based on the displayed parameters, the user may judge the category of the software item associated with the received parameters and effect a corresponding user input. The (inventory) database may then be updated to include the received parameters and the (second) data accordingly.

The method may comprise establishing, using the machine learning algorithm using the first plurality of parameters, the first data, the second plurality of parameters and the second data as input operands, a second logic engine that is non-trivially representative, for each of the plurality of mutually distinct software items and the (another) software item, of the respective category of the respective software item. As such, the logic engine may be updated to reflect updates to the (inventory) database. For example, the logic engine may be updated once parameters and category data for one hundred software items have been added to the (inventory) database since establishment of the most recent logic engine.

The method may comprise communicating (data representative of) the second logic engine to each of a plurality of computer systems, e.g. to a plurality of end-user computers.

While the teachings of the present disclosure have been discussed hereinabove mainly in the form of a method, the teachings may be embodied, mutatis mutandis, in the form of a system, e.g. a software inventory system, or a computer program product, as will be appreciated by the person skilled in the art.

The system may be configured and adapted to effect any of the actions described above with respect to the disclosed method. For example, the system may comprise a control component that effects any of the actions described above with respect to the disclosed method.

The system may comprise a data storage device that stores data representative of a logic engine, e.g. as described hereinabove.

The system may comprise a software detector that detects a software item, e.g. as described hereinabove.

The system may comprise a parameter determiner that determines at least one parameter of a software item, e.g. as described hereinabove.

The system may comprise a category estimator that estimates a category of a software item, e.g. as described hereinabove.

The system may comprise a parameter communicator that communicates a parameter, e.g. as described hereinabove.

The system may comprise a data storage device, e.g. for storing parameters and/or data as described hereinabove.

The system may comprise a logic engine establisher, e.g. for establishing a logic engine as described hereinabove.

The system may comprise a parameter receiver, e.g. for receiving (a plurality of) parameters as described hereinabove.

The system may comprise a data receiver, e.g. for receiving data as described hereinabove.

The system may comprise a data communicator, e.g. for communicating data representative of a logic engine as described hereinabove.

The system may comprise a user input device that receives user inputs as discussed hereinabove.

Any of the aforementioned components of the system may communicate with any other of the aforementioned components of the system. In this respect, the system may comprise one or more communication busses/links interconnecting the respective components.

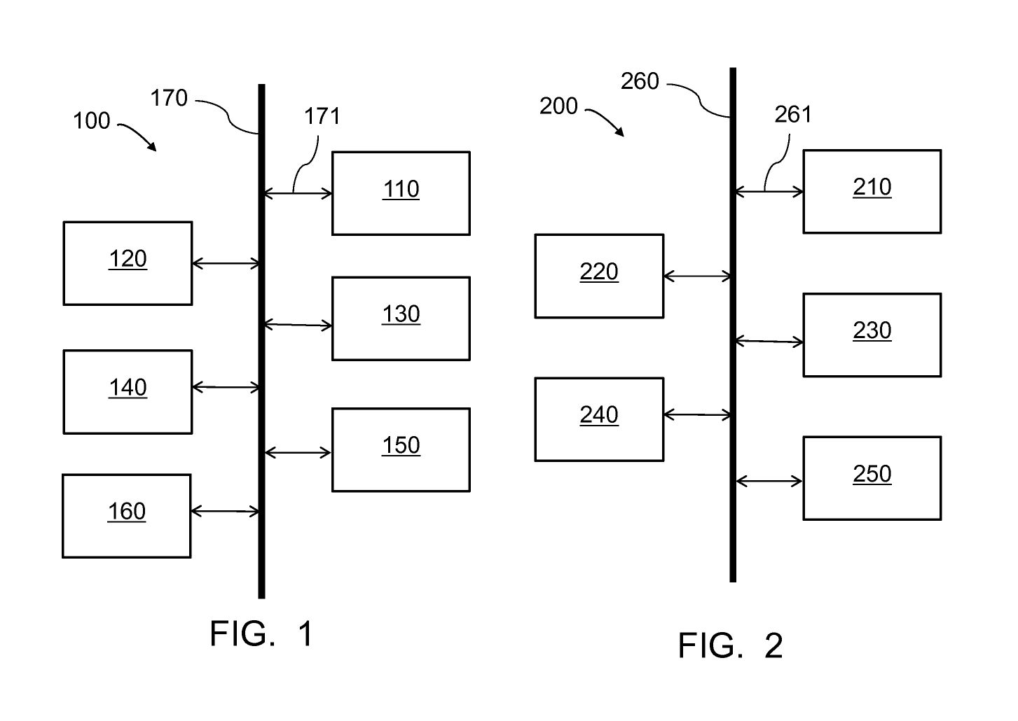

FIG. 1 schematically shows an embodiment of a software inventory system 100 in accordance with the present disclosure, e.g. as described above.

In the illustrated embodiment, software inventory system 100 comprises a data storage device 110, a logic engine establisher 120, an optional parameter receiver 130, an optional data receiver 140, an optional data communicator 150, an optional user input device 160 and a communication bus 170 comprising a plurality of communication links 171 (for the sake of legibility, only one of the communication links bears a reference sign). Communication bus 170 and the communication links 171 communicatively interconnect the aforementioned components 110-160.

FIG. 2 schematically shows another embodiment of a software inventory system 200 in accordance with the present disclosure, e.g. as described above.

In the illustrated embodiment, software inventory system 200 comprises a data storage device 210, a software detector 220, a parameter determiner 230, a category estimator 240, a parameter communicator 250 and a communication bus 260 comprising a plurality of communication links 261 (for the sake of legibility, only one of the communication links bears a reference sign). Communication bus 260 and the communication links 261 communicatively interconnect the aforementioned components 210-150.

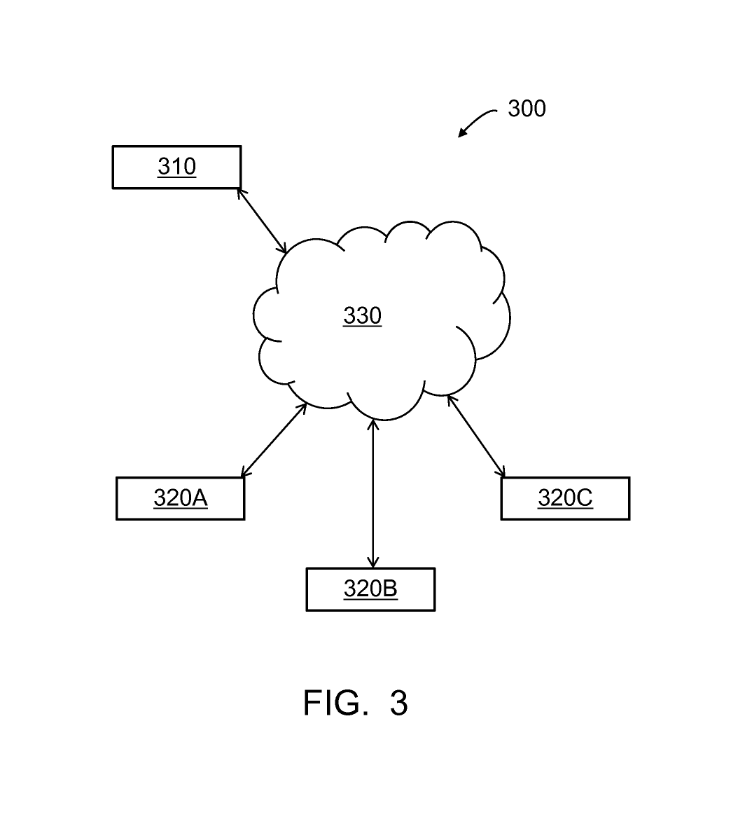

FIG. 3 schematically shows another embodiment of a software inventory system 300 in accordance with the present disclosure, e.g. as described above.

In the illustrated embodiment, software inventory system 300 comprises a computer system in the nature of a server 310 and a plurality of computer systems in the nature of an end-user computer 320A-320C. Server 310 and end-user computers 320A-320C are communicatively interconnected such that each of the end-user computers 320A-320C may communicate with server 310. In the illustrated embodiment, server 310 and end-user computers 320A-320C are networked via the Internet 330. Server 310 may be a software inventory system as shown in FIG. 1, i.e. may comprise the features of software inventory system 100. Any (one or more or each) of end-user computers 320A-320C may be a software inventory system as shown in FIG. 2, i.e. may comprise the features of software inventory system 200.

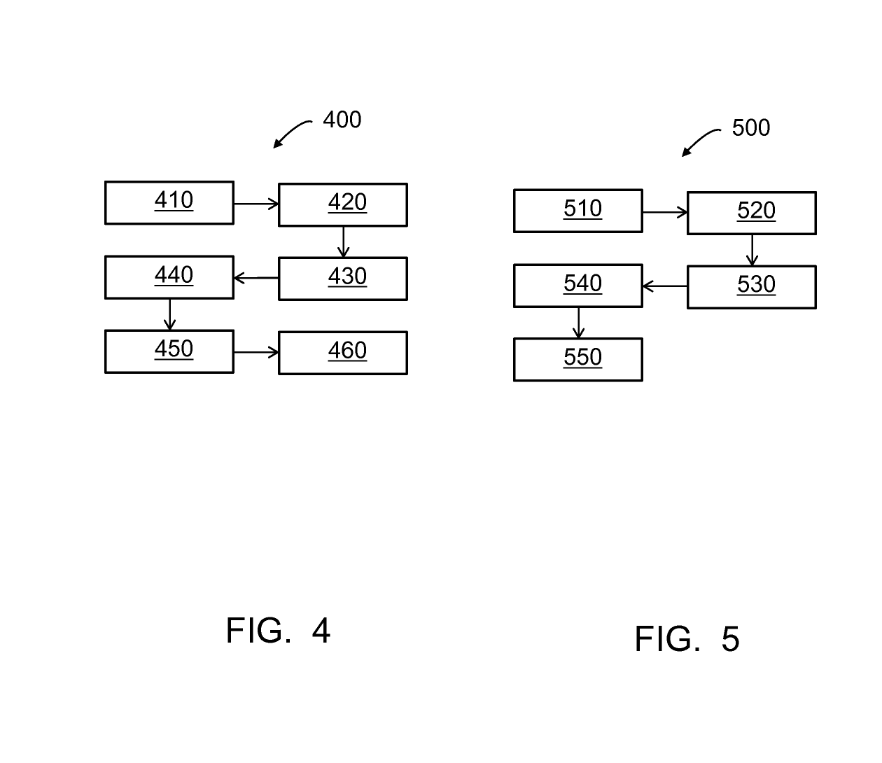

FIG. 4 schematically shows a flow diagram 400 of an embodiment of a software inventory method in accordance with the present disclosure, e.g. as described above.

In the illustrated embodiment, flow diagram 400 comprises a step 410 of storing a plurality of parameters, a step 420 of storing category data, a step 430 of establishing a (first) logic engine, an optional step 440 of receiving a plurality of parameters, an optional step 450 of receiving category data and an optional step 460 of establishing another (second) logic engine.

FIG. 5 schematically shows a flow diagram 500 of an embodiment of a software inventory method in accordance with the present disclosure, e.g. as described above.

In the illustrated embodiment, flow diagram 500 comprises a step 510 of storing data representative of a logic engine, a step 520 of detecting a software item, a step 530 of determining at least one parameter of the software item, a step 540 of estimating a category of the software item and a step 550 of communicating the parameter to a computer system.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described with reference to flowchart illustrations and/or block diagrams of methods, apparatus (systems) and computer program products according to embodiments of the present disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The block diagrams in the Figures illustrate the architecture, functionality, and operation of possible implementations of systems, methods and computer program products according to various embodiments of the present disclosure. In this regard, each block in the block diagrams may represent a module, segment, or portion of code, which comprises one or more executable instructions for implementing the specified logical function(s). It should also be noted that, in some alternative implementations, the functions discussed hereinabove may occur out of the disclosed order. For example, two functions taught in succession may, in fact, be executed substantially concurrently, or the functions may sometimes be executed in the reverse order, depending upon the functionality involved. It will also be noted that each block of the block diagrams, and combinations of blocks in the block diagrams, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. In the present disclosure, the verb “may” is used to designate optionality/noncompulsoriness. In other words, something that “may” can, but need not.

In the present disclosure, the term “receiving” may comprise receiving/obtaining the respective element/information from a storage medium, via a computer network and/or by user input. In the present disclosure, any “receiving” may be accompanied by a “storing” of the received element/information, e.g. in a computer memory, on a hard disk, in a flash storage device or in any other storage device. In other words, where the method comprises a receiving of an element/information, the method may comprise a storing of the received element/information.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A software inventory method, comprising:
storing data representative of a logic engine established via a machine learning algorithm;
detecting a software item on a computer system;
determining at least one parameter of the software item; estimating, using the logic engine and the at least one parameter, a category of the software item; and
communicating the at least one parameter to another computer system in response to the estimated category is a given category.

2. The method of claim 1, wherein:
the logic engine is non-trivially representative, for each of a plurality of mutually distinct software items stored on a computer system, of a category of software items to which the respective software item belongs, and
the plurality of mutually distinct software items comprises more than ten thousand mutually distinct software items.

3. The method of claim 1, wherein:
the logic engine is non-trivially representative, for each of a plurality of mutually distinct software items stored on a computer system and using each of a file size, a file name and a file extension of the respective software item as au input operand of the logic engine, of a category of the respective software item, and
the plurality of mutually distinct software items comprises more than ten thousand mutually distinct software items.

4. The method of claim 1, wherein the logic engine is established by the method comprising:
storing a first plurality of parameters for each of a plurality of mutually distinct software items;
storing, for each of the plurality of mutually distinct software items, first data representative of a category of the respective software item; and
establishing, using the machine learning algorithm using the first plurality of parameters and the first data as input operands, the logic engine that is non-trivially representative, for each of the plurality of mutually distinct software items, of the category of the respective software item, wherein
the plurality of mutually distinct software items comprises more than ten thousand mutually distinct software items.

5. The method of claim 4, wherein the plurality of mutually distinct software items comprises software items belonging to a first category but not a second category and software items belonging to the second category but not the first category.

6. The method of claim 4, further comprising:
receiving a second plurality of parameters for another software item;
receiving second data representative of a category of the another software item; and
establishing, using the machine learning algorithm using the first plurality of parameters, the first data the second plurality of parameters and the second data as input operands, another logic engine that is non-trivially representative, for each of the plurality of mutually distinct software items and the another software item, of the respective category of the respective software item.

7. The method of claim 6, further comprising:
communicating data representative of the second logic engine to each of a plurality of computer systems.

8. A software inventory system (200), comprising:
a processor; and
a memory coupled to the processor, wherein the memory comprises instructions which, when executed by the processor, cause the processor to:
store data representative of a logic engine established via a machine learning algorithm;
detect a software item on a computer system;
determine at least one parameter of the software item;
estimate, using the logic engine and the at least one parameter, a category of the software item; and
communicate the at least one parameter to another computer system in response to the estimated category is a given category.

9. The system of claim 8, wherein:
the logic engine is non-trivially representative, for each of a plurality of mutually distinct software items stored on a computer system, of a category of software items to which the respective software item belongs, and
the plurality of mutually distinct software items comprises more than ten thousand mutually distinct software items.

10. The system of claim 8, wherein:
the logic engine is non-trivially representative, for each of a plurality of mutually distinct software items stored on a computer system and using each of a file size, a file name and a file extension of the respective software item as an input operand of the logic engine, of a category of the respective software item, and
the plurality of mutually distinct software items comprises more than ten thousand mutually distinct software items.

11. The system of claim 8, wherein the instructions to establish the logic engine further cause the processor to:
store a first plurality of parameters for each of a Plurality of mutually distinct software items,
store, for each of the plurality of mutually distinct software items, first data representative of category of the respective software item, and
establish, using the machine learning algorithm using the first plurality of parameters and the first data as input operands, the logic engine that is non-trivially representative, for each of the plurality of mutually distinct software items, of the category of the respective software item, wherein
the plurality of mutually distinct software items comprises more than ten thousand mutually distinct software items.

12. The system of claim 11, wherein the plurality of mutually distinct software items comprises software items belonging to a first category but not a second category and software items belonging to the second category but not the first category.

13. The system of claim 11, wherein the instructions further cause the processor to:
receive a second plurality of parameters for another software item;
receive second data representative of a category of the another software item; and
establish, using the machine learning algorithm using the first plurality of parameters, the first data, the second plurality of parameters and the second data as input operands, a second logic engine that is non-trivially representative, for each of the plurality of mutually distinct software items and the another software item, of the respective category of the respective software item.

14. The system of claim 13, wherein the instructions further cause the processor to:
communicate data representative of the second logic engine to each of a plurality of computer systems.

15. A computer program product comprising a computer readable storage medium, having a computer readable program stored therein, wherein the computer readable program, when executed on a computing device, causes the computing device to
store data representative of a logic engine established via a machine learning algorithm;
detect a software item on a computer system;
determine at least one parameter of the software item;
estimate, using the logic engine and the at least one parameter, a category of the software item; and
communicate the at least one parameter to another computer system in response to the estimated category is a given category.

16. The computer program product of claim 15, wherein:
the logic engine is non-trivially representative, for each of a plurality of mutually distinct software items stored on a computer system, of a category of software items to which the respective software item belongs, and
the plurality of mutually distinct software items comprises more than ten thousand mutually distinct software items.

17. The computer program product of claim 15, wherein:
the logic engine is non-trivially representative, for each of a plurality of mutually distinct software items stored on a computer system and using each of a file size, a file name and a file extension of the respective software item as an input operand of the logic engine, of a category of the respective software item, and
the plurality of mutually distinct software items comprises more than ten thousand mutually distinct software items.

18. The computer program product of claim 15, wherein the instructions to establish the logic engine further cause the processor to:
store a first plurality of parameters for each of a plurality of mutually distinct software items,
store, for each of the plurality of mutually distinct software items, first data representative of a category of the respective software item, and
establish, using the machine learning algorithm using the first plurality of parameters and the first data as input operands, the logic engine that is non-trivially representative, for each of the plurality of mutually distinct software items, of the category of the respective software item, wherein
the plurality of mutually distinct software items comprises more than ten thousand mutually distinct software items.

19. The computer program product of claim 18, wherein the plurality of mutually distinct software items comprises software items belonging to a first category but not a second category and software items belonging to the second category but not the first category.

20. The computer program product of claim 18, wherein the instructions further cause the processor to:
receive a second plurality of parameters for another software item;
receive second data representative of a category of the another software item;
establish, using the machine learning algorithm using the first plurality of parameters, the first data, the second plurality of parameters and the second data as input operands, a second logic engine that is non-trivially representative, for each of the plurality of mutually distinct software items and the another software item, of the respective category of the respective software item; and
communicate data representative of the second logic engine to each of a plurality of computer systems.
